(19) United States
(12) Patent Application Publication
(10) Pub. No.: US 2022/0350005 A1
(43) Pub. Date: Nov. 3, 2022

(54) ATTITUDE SYNCHRONOUS SONAR SYSTEM

(71) Applicant: Garmin International, Inc., Olathe, KS (US)

(72) Inventors: Robert W. Derrow, II, Overland Park, KS (US); Michael D. Rogers, West Fargo, ND (US)

(21) Appl. No.: 17/650,987

(22) Filed: Feb. 14, 2022

Related U.S. Application Data
(60) Provisional application No. 63/183,132, filed on May 3, 2021.

(51) Int. Cl. G01S 7/523; G01S 15/89; G01S 7/524; G01S 7/529; G01C 9/06

(52) U.S. Cl. CPC G01S 7/523; G01S 15/89; G01S 7/524; G01S 7/529; G01C 9/06

(57) ABSTRACT

A marine sonar system comprises a sonar transducer, an attitude sensor, and a processing element. The sonar transducer is configured to transmit a sonar beam into a body of water according to a transmit electronic signal, receive reflections of the sonar beam, and output a receive electronic signal according to the reflections of the sonar beam. The attitude sensor is configured to determine an attitude angle of a marine vessel with which the marine sonar system is utilized and to output an attitude electronic signal whose value varies according to the attitude angle. The processing element configured to receive the attitude electronic signal receive and, based on the attitude electronic signal, control the output of the transmit electronic signal to the sonar transducer.

### RELATED APPLICATIONS

The current patent application is a regular utility patent application which itself claims priority benefit, with regard to all common subject matter, of earlier-filed U.S. Provisional Application entitled “ATTITUDE SYNCHRONOUS SONAR TRANSMISSION”, Ser. No. 63/183,132, filed May 3, 2021. The Provisional Application is hereby incorporated by reference, in its entirety, into the current patent application.

### BACKGROUND

Marine sonar (sound navigation and ranging) systems are utilized with a marine vessel on a body of water and include a display to display underwater sonar images which depict objects in the water beneath and/or to the sides of the marine vessel. The system also includes a sonar transducer, often mounted to a hull of the marine vessel, which transmits a sonar beam and receives reflections of the sonar beam from objects in the water, such as fish, and from the bottom of the body of water. Some sonar transducers transmit a non-steerable or fixed orientation sonar beam so that the beam is transmitted only in a direction in which the sonar transducer is pointed. When the marine vessel encounters waves, a wake, or otherwise turbulent water, the marine vessel pitches and rolls, and the sonar beam may be transmitted in a direction in which the reflections of the sonar beam from the bottom of the water are not received by the sonar transducer—or the received signals are very weak. In these situations, the quality of the underwater sonar images may suffer.

### SUMMARY

Embodiments of the present technology provide a marine sonar system that generates improved underwater sonar image quality when a marine vessel with which the system is utilized encounters choppy waters. An embodiment of the system broadly comprises a sonar transducer, an attitude sensor, and a processing element. The sonar transducer is configured to transmit a sonar beam into a body of water according to a transmit electronic signal, receive reflections of the sonar beam, and output a receive electronic signal according to the reflections of the sonar beam. The attitude sensor is configured to determine an attitude angle of a marine vessel with which the marine sonar system is utilized and to output an attitude electronic signal whose value varies according to the attitude angle. The processing element configured to receive the attitude electronic signal receive and, based on the attitude electronic signal, control the output of the transmit electronic signal to the sonar transducer.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWING FIGURES

Embodiments of the present technology are described in detail below with reference to the attached drawing figures, wherein:

FIG. 1 is a schematic block diagram of various components of a marine sonar system, constructed in accordance with embodiments of the present technology;

FIG. 2 is a perspective view of a housing and display of the marine sonar system;

FIG. 3 is a side view of a marine vessel on a body of water, the marine vessel including a sonar transducer transmitting a sonar beam at a pitch angle that is approximately 0 degrees;

FIG. 4 is a side view of the marine vessel with the sonar transducer transmitting the sonar beam at a large pitch angle such that the sonar beam is not received by the sonar transducer;

FIG. 5 is a front view of the marine vessel with the sonar transducer transmitting the sonar beam at a roll angle that is approximately 0 degrees; and

FIG. 6 is a front view of the marine vessel with the sonar transducer transmitting the sonar beam at a large roll angle such that the sonar beam is not received by the sonar transducer.

The drawing figures do not limit the present technology to the specific embodiments disclosed and described herein. While the drawings do not necessarily provide exact dimensions or tolerances for the illustrated components or structures, the drawings are to scale as examples of certain embodiments with respect to the relationships between the components of the structures illustrated in the drawings.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Relational terms, such as “above”, “below”, “over”, “beneath”, “upper”, “upward”, “lower”, “downward”, “top”, “bottom”, “outer”, “inner”, etc., may be used throughout this description. These terms are used with reference to embodiments of the technology and the orientations and relative positionings of the components thereof shown in the accompanying figures. Embodiments of the technology may be oriented and/or positioned in ways other than those shown in the figures. Therefore, the terms do not limit the scope of the present technology.

Embodiments of the present technology relate to a marine sonar system. The system is utilized with a marine vessel and displays underwater sonar images which depict objects in a body of water beneath and/or to the sides of the marine vessel. The system includes at least one sonar transducer that is mounted to a hull of the marine vessel. The sonar transducer transmits a sonar beam and receives reflections of the sonar beam from objects in the water, such as fish, and from the bottom of the body of water. The sonar transducer transmits the sonar beam according to a transmit electronic signal and outputs a receive electronic signal according to the received reflections. The marine sonar system includes a processing element which outputs the transmit electronic signal to the sonar transducer and receives the receive electronic signal. In order to avoid transmitting the sonar beam when the reflections may not be received by the sonar transducer, the system includes an attitude sensor which outputs attitude information such as an attitude angle and/or a pitch angle and a roll angle of the marine vessel. Thus, the processing element may determine when the marine vessel is level, i.e., when the attitude angle and/or the pitch angle and the roll angle are approximately 0 degrees, and output the transmit electronic signal to the sonar transducer to transmit the sonar beam. However, there is also a range of values of the attitude angle and/or the pitch angle and the roll angle for which the sonar beam can be transmitted and still be received by the sonar transducer. The processing element may output the transmit electronic signal when the values of the attitude angle and/or the pitch angle and the roll angle are within the range of acceptable values. And, of course, the processing element may utilize any range of attitude data to determine when to output the transmit electronic signal.

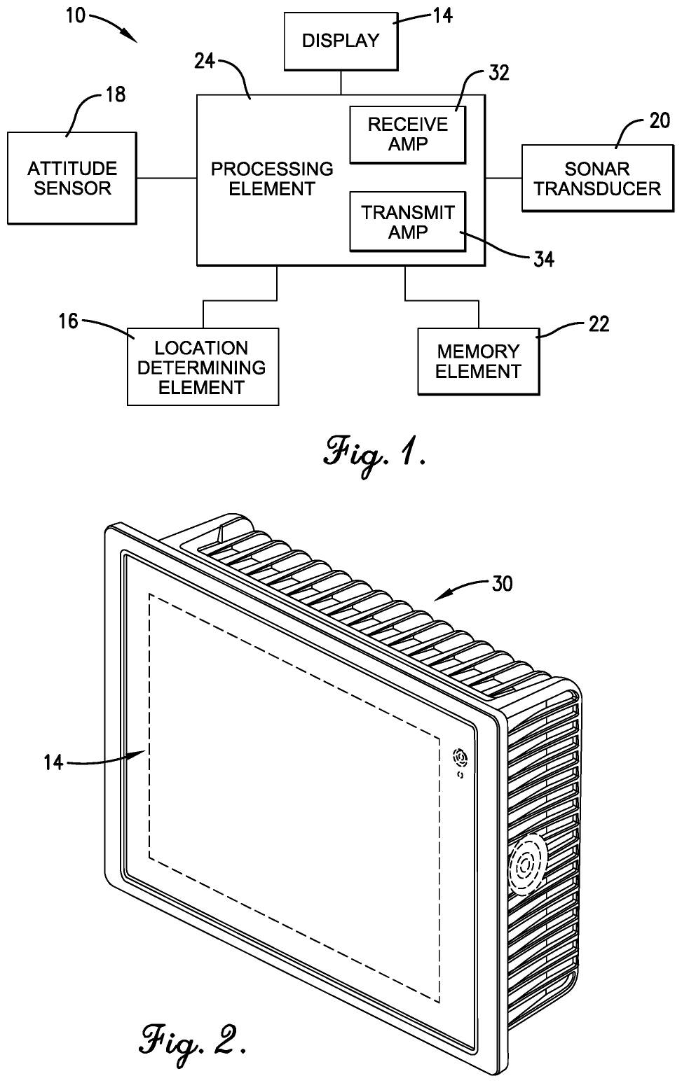

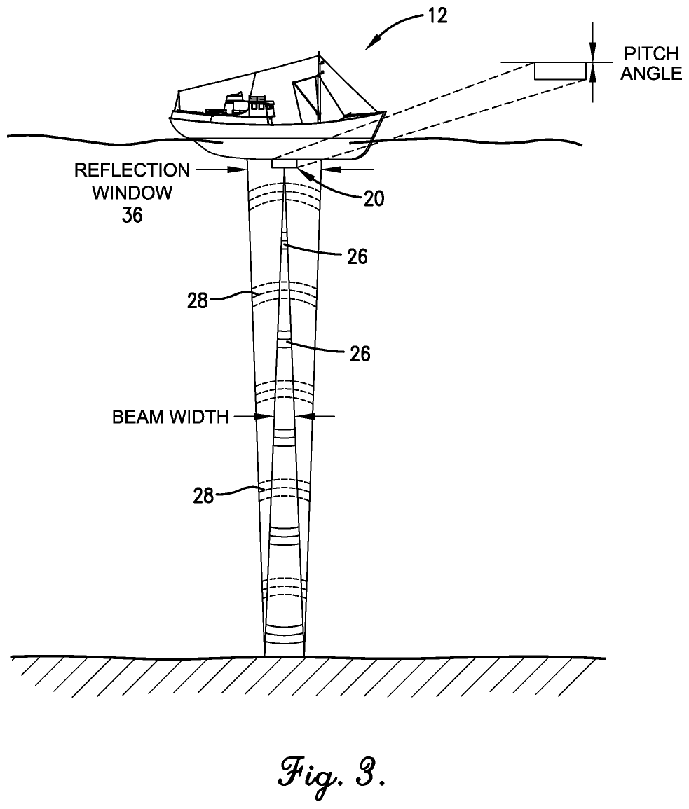

Embodiments of the technology will now be described in more detail with reference to the drawing figures. Referring initially to FIGS. 1 and 2, a marine sonar system 10 is illustrated for use with a marine vessel 12 that is traveling or stationary on a body of water. The vessel 12 may be any object capable of placement within a body of water, including but not limited to a boat, a ship, a kayak, a canoe, a buoy, a float, a bobber, a submersible, an autonomous vehicle, combinations thereof, and the like.

The sonar system 10 broadly comprises a display 14, a location determining element 16, an attitude sensor 18, a sonar transducer 20, a memory element 22, and a processing element 24. The sonar transducer 20 transmits a sonar beam 26 and receives its reflection 28. The display 14 displays underwater sonar images that are derived from reflections 28 of the sonar beam 26.

The marine sonar system 10 may further include a housing 30 which retains and encloses system components such as the display 14, the location determining element 16, the memory element 22, and the processing element 24. The attitude sensor 18 may be retained within the housing 30 or may be located externally. The sonar transducer 20 is positioned external to the housing 30, as discussed in more detail below. The housing 30 may be generally rectangular box shaped with a top wall, a bottom wall, two side walls, a rear wall, and a front wall on which the display 14 is positioned. The housing 30 may be configured to fit within a console or be mounted on a console surface.

The display 14 may include video devices of the following types: plasma, light-emitting diode (LED), organic LED (OLED), Light Emitting Polymer (LEP) or Polymer LED (PLED), liquid crystal display (LCD), thin film transistor (TFT) LCD, LED side-lit or back-lit LCD, or the like, or combinations thereof. The display 14 may include a screen on which information is presented, with the screen possessing any one of a variety of shapes, such as a square or a rectangular aspect ratio that may be viewed in either a landscape or a portrait mode. In various embodiments, the display 14 may also include a touch screen occupying the entire screen or a portion thereof so that the display 14 functions as part of a user interface. The touch screen may allow the user to interact with the marine sonar system 10 by physically touching, swiping, or gesturing on areas of the screen. The display 14 may be in electronic communication with the memory element 22 and the processing element 24 and may receive data or information therefrom that is to be shown on the display 14.

The location determining element 16 generally determines a current geolocation of the marine sonar system 10 (and by extension, the marine vessel 12) and may receive and process radio frequency (RF) signals from a multi-constellation global navigation satellite system (GNSS) such as the global positioning system (GPS) utilized in the United States, the Galileo system utilized in Europe, the GLONASS system utilized in Russia, or the like. The location determining element 16 may accompany or include an antenna to assist in receiving the satellite signals. The antenna may be a patch antenna, a linear antenna, or any other type of antenna that can be used with location or navigation devices. The location determining element 16 may include satellite navigation receivers, processors, controllers, other computing devices, or combinations thereof, and memory. The location determining element 16 may process a location electronic signal communicated from the antenna which receives the location wireless signal from one or more satellites of the GNSS. The location wireless signal includes data from which geographic information such as the current geolocation is derived. The current geolocation may include coordinates, such as the latitude and longitude, of the current location of the marine vessel 12. The location determining element 16 may communicate the current geolocation to the processing element 24, the memory element 22, or both.

Although embodiments of the location determining element 16 may include a satellite navigation receiver, it will be appreciated that other location-determining technology may be used. For example, cellular towers or any customized transmitting radio frequency towers can be used instead of satellites to determine the location of the marine sonar system 10 by receiving data from at least three transmitting locations and then performing basic triangulation calculations to determine the relative position of the device with respect to the transmitting locations. With such a configuration, any standard geometric triangulation algorithm can be used to determine the location of the marine sonar system 10. The location determining element 16 may also include or be coupled with a pedometer, accelerometer, compass, or other dead-reckoning components which allow it to determine the location of the marine sonar system 10. The location determining element 16 may determine the current geographic location through a communications network, such as by using Assisted GPS (A-GPS), or from another electronic device. The location determining element 16 may even receive location data directly from a user.

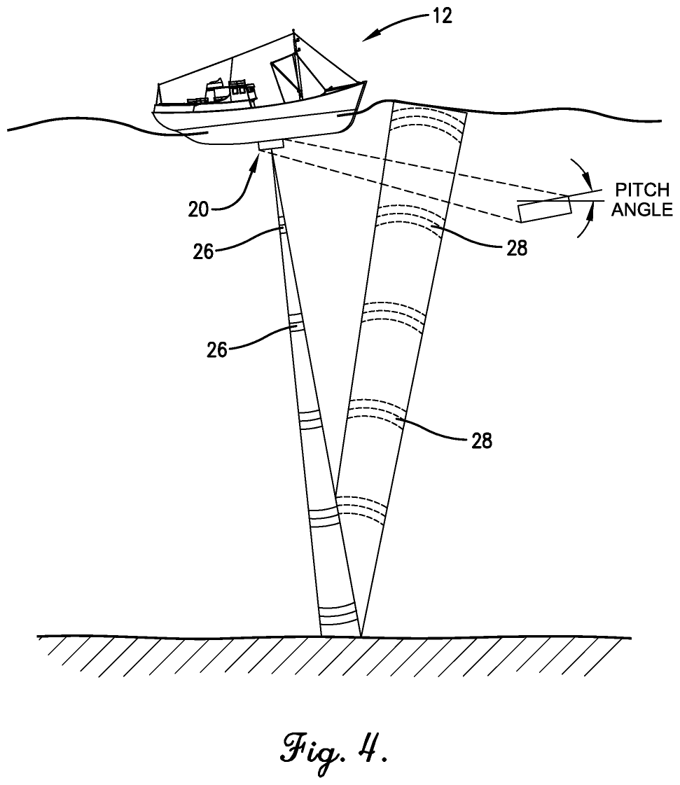

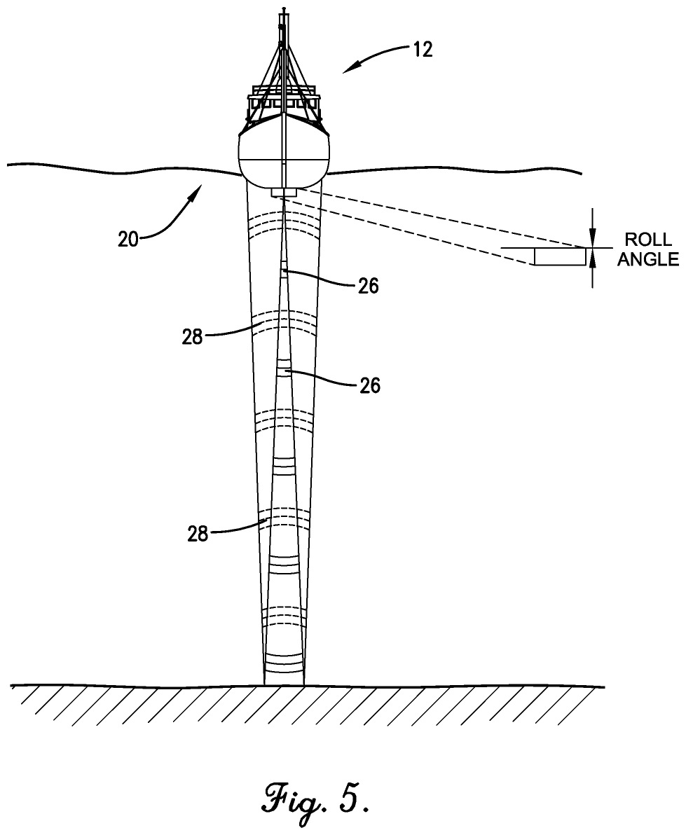

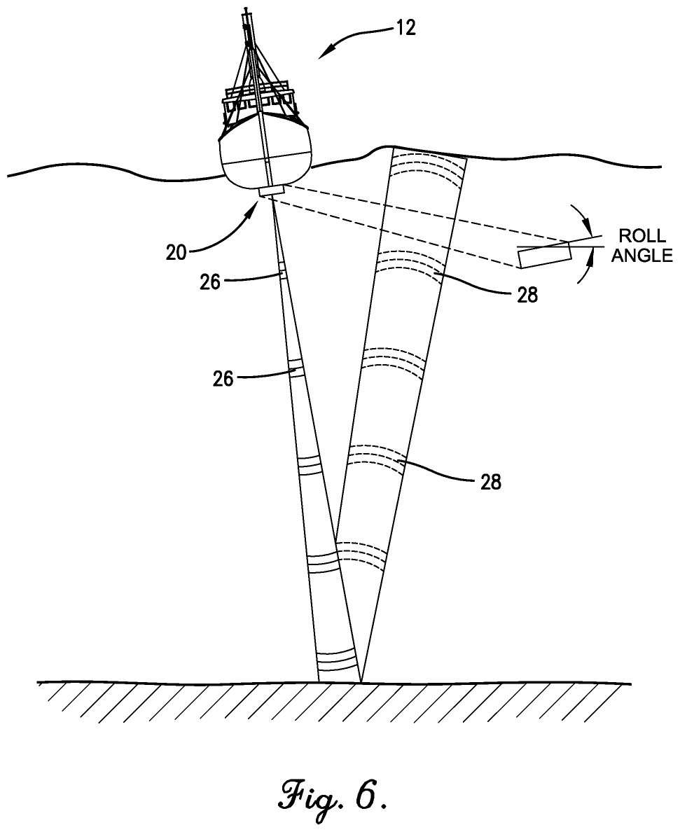

The attitude sensor 18 is configured to determine attitude information, such as a pitch angle and a roll angle of the marine vessel 12. The pitch angle is an angle between a line along the forward-to-aft axis and the horizontal plane, as shown in FIGS. 3 and 4. The roll angle is an angle between a line along the port-to-starboard axis and the horizontal plane, as shown in FIGS. 5 and 6. The attitude sensor 18 may include spatial orientation and motion components and devices such as gyroscopes, accelerometers, magnetometers, tilt sensors, tilt switches, and the like, or combinations thereof, as well as filters, amplifiers, analog to digital converters (ADCs), signal and/or data processors, and the like. The attitude sensor 18 outputs an attitude electronic signal whose analog electric characteristic (electric voltage and/or electric current) level or digital data value varies according to the pitch angle and the roll angle. For example, the attitude electronic signal may include a first digital data value representative of the pitch angle and a second digital data value representative of the roll angle. The first digital data value and the second digital data value may each be updated with current readings periodically, such as between 10 times per second and 100 times per second. In some configurations, the attitude sensor 18 is a multi-axis accelerometer that outputs acceleration information for three or more axis (e.g., X, Y, and Z) from which pitch and roll information may be calculated. However, additionally or alternatively, the attitude sensor 18 may include one or more gyroscopes, such as MEMS gyroscopes, to determine heading and orientation information.

The attitude sensor 18 itself may determine pitch and roll information, or other attitude-related information, based on sensor information and/or the attitude sensor 18 may output attitude data to the processing element 24 via the attitude electronic signal for computation of attitude-related information including pitch and roll. In some embodiments the processing element 24 and attitude sensor 18 may be integrated or partially integrated, such as where the attitude sensor 18 is configured as a system on a chip with both sensor and processing components. The attitude sensor 18 may be integrated within other components of the system, such as the sonar transducer 20, and/or be configured for placement on or within the vessel 12.

Additionally, or alternatively, the attitude sensor 18 may determine an attitude of the marine vessel 12, wherein the attitude is an orientation relative to the horizontal plane which takes into account both the pitch angle and the roll angle. The attitude may be an angular value expressed in terms of degrees, wherein approximately 0 degrees is approximately 0 degrees for the pitch angle and approximately 0 degrees for the roll angle and means that the marine vessel 12 is “on axis” or “level”—that is, aligned with, or parallel to, the horizontal plane. Any non-zero degree value of the attitude equates to a non-zero value of the pitch angle and/or the roll angle and means that the marine vessel 12 is not level and is tilting in some direction.

The sonar transducer 20 may include one or more elements that are formed from piezoelectric material, like ceramics such as lead zirconate titanate (PZT) or polymers such as polyvinylidene difluoride (PVDF), which transforms electrical energy from electronic signals into mechanical energy for sonar beams and vice versa. In some embodiments, the sonar transducer 20 may also include electric circuitry and components such as controllers, processors, filters, amplifiers, ADCs, digital to analog converters (DACs), and the like. The sonar transducer 20 may further include a housing in which the elements and electric circuitry are retained. The housing and the sonar transducer 20 may be mounted for through hull operation, mounted on the bottom of the hull, or mounted on the transom.

The sonar transducer 20 generally transmits the sonar beam 26 and receives reflections 28 of the sonar beam 26 from objects and surfaces in the body of water in which the sonar transducer 20 is utilized. In more detail, the sonar transducer 20 may function as an acoustic (pressure) wave transmitter or an acoustic wave receiver. When operating as an acoustic wave transmitter, the sonar transducer 20 may generate or transmit acoustical, pressure, mechanical, and/or vibrational waves with magnitude and frequency components that correspond to the magnitude and frequency components of a transmit electronic signal that is received from the processing element 24. Typically, the acoustic radiation is a sequence of energy pulses or a sequence of groups of energy pulses.

The acoustic radiation transmitted from the sonar transducer 20 may have a distribution of power versus rotation angle of transmission. If the angle that is normal to the surface of the sonar transducer 20 is considered a 0 degree axis, then a large portion of the power of the transmitted radiation is distributed in a main lobe that is centered at 0 degrees. Decreasing amounts of power are distributed in side lobes positioned at greater angles both clockwise and counterclockwise away from the 0 degree axis. What is considered the sonar beam 26 is a range of angles of the transmitted radiation (generally along the main lobe) in which the power of the radiation is greater than a particular threshold—for example, 50%. The sonar beam 26 has a beam width as shown in FIG. 3. The beam width may be given as a particular width at a particular length, or as an angular value, such as 10 degrees, 20 degrees, 30 degrees, or the like, that indicates an angle from one edge of the sonar beam 26 to the opposing edge of the sonar beam 26. The pattern of the power distribution and the value of the beam width may be different for each sonar transducer 20, or at least each type of sonar transducer 20, and may vary according to parameters such as a number of transducing elements, a size of the elements, the configuration or arrangement of the elements, the material from which the elements are formed, and so forth. The sonar beam 26 typically has a conical or triangular profile with a circular cross section or spot shape. In other embodiments, the sonar beam 26 may have a conical or triangular profile with an oval, elliptical, or similar cross section or spot shape.

When operating as an acoustic wave receiver, the sonar transducer 20 may output a receive electronic signal with magnitude and frequency components that correspond to the magnitude and frequency components of the pressure, acoustical, mechanical, and/or vibrational waves, i.e., reflections 28 of the sonar beam 26, impinging on one or more of the surfaces of the sonar transducer 20. In some embodiments, the receive electronic signal may be an analog signal with varying levels of electric voltage and/or electric current. In other embodiments, the receive electronic signal may include a stream of digital data values.

When the sonar transducer 20 receives reflections 28 of the sonar beam 26, acoustic radiation power is transferred from the reflections 28 to the sonar transducer 20. As with the acoustic radiation transmitted by the sonar transducer 20, the acoustic radiation received by the sonar transducer 20 may have a distribution of power versus rotation angle of reception. Typically, the pattern of distribution is the same for receiving radiation as it is for transmitting radiation. That is, a large portion of the power of the received radiation is distributed in a main lobe that is centered at 0 degrees. Decreasing amounts of power are distributed in side lobes positioned at greater angles both clockwise and counterclockwise away from the 0 degree axis. As the power of the received radiation decreases, the amplitude of the receive electronic signal output by the sonar transducer 20 decreases as well. Thus, the amplitude of the receive electronic signal varies according to the angle at which the reflections 28 of the sonar beam 26 are received by the sonar transducer 20.

The memory element 22 may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, solid state memory, or the like, or combinations thereof. In some embodiments, the memory element 22 may be embedded in, or packaged in the same package as, the processing element 24. The memory element 22 may include, or may constitute, a non-transitory “computer-readable medium”. The memory element 22 may store the instructions, code, code statements, code segments, software, firmware, programs, applications, apps, services, daemons, or the like that are executed by the processing element 24. The memory element 22 may also store data that is received by the processing element 24 or the device in which the processing element 24 is implemented. The processing element 24 may further store data or intermediate results generated during processing, calculations, and/or computations as well as data or final results after processing, calculations, and/or computations. In addition, the memory element 22 may store settings, text data, documents from word processing software, spreadsheet software and other software applications, sampled audio sound files, photograph or other image data, movie data, databases, and the like.

The processing element 24 may comprise one or more processors. The processing element 24 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The processing element 24 may generally execute, process, or run instructions, code, code segments, code statements, software, firmware, programs, applications, apps, processes, services, daemons, or the like. The processing element 24 may also include hardware components such as registers, finite-state machines, sequential and combinational logic, configurable logic blocks, and other electronic circuits that can perform the functions necessary for the operation of the current invention. In certain embodiments, the processing element 24 may include multiple computational components and functional blocks that are packaged separately but function as a single unit. In some embodiments, the processing element 24 may further include multiprocessor architectures, parallel processor architectures, processor clusters, and the like, which provide high performance computing. The processing element 24 may be in electronic communication with the other electronic components of the marine sonar system 10 through serial or parallel links that include universal busses, address busses, data busses, control lines, and the like. In addition, the processing element 24 may include ADCs to convert analog electronic signals to (streams of) digital data values and/or DACs to convert (streams of) digital data values to analog electronic signals.

Furthermore, the processing element 24 may include or be in electronic communication with a receive amplifier 32 and a transmit amplifier 34. The receive amplifier 32 is configured to amplify the receive electronic signal from the sonar transducer 20 and may include electronic amplifier circuits such as small signal amplifiers, low noise amplifiers, or combinations thereof. A gain of the receive amplifier 32 may be variable, and a value of the gain may be set by the processing element 24. The transmit amplifier 34 is configured to output the transmit electronic signal and may include single stage or multi stage power amplifiers or the like.

The processing element 24 may be operable, configured, or programmed to perform the following functions, processes, or methods by utilizing hardware, software, firmware, or combinations thereof. Other components, such as the memory element 22, may be utilized as well. The processing element 24 receives the current geolocation data from the location determining element 16, indicating the current location of the marine vessel 12. The memory element 22 may have stored in memory a database that includes water depth data based on current location. Thus, the processing element 24 may be able to determine the depth of the water at the current location of the marine vessel 12 by retrieving water depth data from the memory element 22.

The processing element 24 also may receive information regarding the model of the sonar transducer 20, either at the time of manufacture or from the user during usage, from which the beam width of the sonar beam 26 (indicated in FIG. 3) or other characteristics of the transducer 20 can be derived or retrieved. Given the current water depth and the beam width, the processing element 24 determines a reflection window 36, as shown in FIG. 3, which is the portion of the reflection of the sonar beam 26 in which the power or energy of the reflection is above a particular threshold at the surface of the water. The processing element 24 may utilize trigonometric functions, such as the tangent, with the angle, or half angle, of the beam width and the depth to determine a width of the reflection window 36. In addition, if the sonar beam 26 has an elliptical, oval, or similar cross section, then the processing element 24 may determine a first width of the reflection window 36 in the forward and aft direction and a second width of the reflection window 36 in the port and starboard direction.

The processing element 24 also receives the attitude electronic signal from the attitude sensor 18. From the attitude electronic signal, the processing element 24 retrieves or determines the pitch angle and the roll angle. In some configurations, the attitude electronic signal may include data directly corresponding to pitch and roll. Additionally or alternatively, the attitude electronic signal can include acceleration information, such as acceleration along one or more axis, and/or heading information, from which the processing element 24 may compute pitch, roll, angle, direction, and/or other attitude metrics that are suitable for controlling the operation of the transducer 20.

As shown in FIGS. 3 and 4, a change in the pitch angle causes the reflection window 36 to travel or move forward and aft with respect to the marine vessel 12. For example, a positive change in the pitch angle may cause the reflection window 36 to move forward (as shown in FIG. 4), while a negative change in the pitch angle may cause the reflection window 36 to move aft, or vice-versa. Likewise, as shown in FIGS. 5 and 6, a change in the roll angle causes the reflection window 36 to travel or move to port (left) and starboard (right) with respect to the marine vessel 12. For example, a positive change in the roll angle may cause the reflection window 36 to move to port (as shown in FIG. 6), while a negative change in the roll angle may cause the reflection window 36 to move to starboard, or vice-versa.

Furthermore, as shown in FIGS. 4 and 6, as the magnitudes of the pitch angle and the roll angle change to larger values, the sonar transducer 20 is no longer within the reflection window 36. Thus, there is a first range of values of the pitch angle for which the sonar transducer 20 can transmit the sonar beam 26 and the sonar transducer 20 will be within the reflection window 36. And, there is a second range of values of the roll angle for which the sonar transducer 20 can transmit the sonar beam 26 and the sonar transducer 20 will be within the reflection window 36. For example, the range of values for the pitch angle and the roll angle may each include a nominal value plus and minus a limit value. Typically, the nominal value is 0 degrees (the horizontal plane). If the sonar beam 26 has a circular cross section, then the limit value is usually the same for the pitch angle and the roll angle—meaning that the first range of values is equivalent to the second range of values. As an example, the limit value may range from +/−approximately 3 degrees to +/−approximately 5 degrees, or a similar range. If the sonar beam 26 has an elliptical, oval, or similar cross section, then the limit value may be different for the pitch angle and the roll angle. As an example, the limit value for the pitch angle may range from +/−approximately 3 degrees to +/−approximately 5 degrees, or a similar range, and the limit value for the roll angle may range from +/−approximately 10 degrees to +/−approximately 14 degrees, or a similar range, or vice versa. These embodiments may be static values stored within the memory 22, dynamic values computer by the processing element 24 in real time, and/or user-configurable values set by the user.

The processing element 24 may determine the limit values according to, or based on, the beam width. In general, a wider beam width produces a greater limit value which produces an increase in the first range of values and an increase in the second range of values. Conversely, a narrower beam width produces a smaller limit value which produces a decrease in the first range of values and a decrease in the second range of values.

In various embodiments, the processing element 24 may also, or instead, retrieve or determine an attitude angle from the attitude electronic signal. The attitude angle has an attitude range of values for which the sonar transducer 20 will be in the reflection window 36. The attitude range of values may be similar to, or the same as, either the first range of values or the second range of values. For example, the attitude range of values may range from −5 degrees to +5 degrees.

The processing element 24 outputs the transmit electronic signal to be received by the sonar transducer 20. The transmit electronic signal may include varying analog electric voltage and/or electric current levels, digital data values, one or more pulses, groups of pulses, or other characteristics that instruct or control the sonar transducer 20 to transmit the sonar beam 26. In some configurations, the processing element 24 outputs the transmit electronic signal when the marine vessel 12 is level. That is, the processing element 24 outputs the transmit electronic signal when the attitude angle or the pitch angle and the roll angle are approximately 0 degrees.

Given that the sonar transducer 20 receives the reflection of the sonar beam 26 only when the sonar transducer 20 is within the reflection window 36, the processing element 24 outputs the transmit electronic signal according to, or based on, the values of the attitude-related information corresponding to the attitude electronic signal, such as pitch angle, roll angle, attitude angle, heading, orientation, combinations thereof, and the like. That is, the processing element 24 outputs the transmit electronic signal when the attitude angle or other metric has a value within the attitude range of values. Alternatively, the processing element 24 outputs the transmit electronic signal when the pitch angle has a value within the first range of values and the roll angle has a value within the second range of values. In some instances, the processing element 24 may output the transmit electronic signal to prioritize the motion along one axis over the motion along the other axis. For example, the processing element 24 may output the transmit electronic signal when the pitch angle has a value within the first range of values no matter what the value of the roll angle is, or vice versa. Of course, any combination of attitude-related information may be utilized by the processing element 24 to determine when to output the transmit electronic signal to achieved proper performance of the transducer 20.

As discussed above, the amplitude of the receive electronic signal varies according to the angle at which the reflections 28 of the sonar beam 26 are received by the sonar transducer 20. When the sonar transducer 20 is mounted to the marine vessel 12, the angle at which the reflections 28 of the sonar beam 26 are received varies according to, or is determined by, the pitch angle and the roll angle of the marine vessel 12. When the amplitude of the receive electronic signal decreases below a certain threshold, the signal may be too small to amplify properly. Thus, there are a range of attitude angles or pitch angles and a range of roll angles within which the receive electronic signal may be amplified properly in order for the processing element 24 to derive reflection data in order to generate sonar images of underwater objects. Given that the sonar transducer 20 has a similar power distribution pattern when receiving radiation as it does when transmitting radiation, the range of attitude angles or pitch angles and roll angles may be the same or similar for receiving reflections 28 as they are for transmitting the sonar beam 26. That is, the receive amplifier 32 may only be able to amplify the receive electronic signal when the attitude angle has a value within the attitude range of angles or the pitch angle has a value within the first range of values and the roll angle has a value within the second range of values.

In some situations, the processing element 24 may output the transmit electronic signal for the sonar transducer 20 to transmit the sonar beam 26 so that the reflection will be received when the sonar transducer 20 is in the reflection window 36, but before the reflection is received, the value of the attitude angle increases beyond the attitude range of angles, or the value of the pitch angle increases beyond the first range of values and/or the value of the roll angle increases beyond the second range of values. In such situations, the processing element 24 may receive or retrieve the current values, and/or historical values, of the attitude angle or the pitch angle and the roll angle and utilize artificial intelligence and/or machine learning techniques, such as artificial neural networks, convolutional neural networks, modeling, and the like, to predict future values of the attitude angle or the pitch angle and the roll angle. Thus, the processing element 24 may predict when the attitude angle will have a value within the attitude range of angles or the pitch angle will have a value within the first range of values and the roll angle will have a value within the second range of values.

Additionally, or alternatively, the processing element 24 may utilize a sinusoid summation technique involving one wave, two waves, or three waves to model the dynamics (i.e., the motion) of the marine vessel 12 in order to predict or determine future values of the attitude angle or the pitch angle and the roll angle. Specifically, the processing element 24 may predict or determine when the pitch angle will have a value within the first range of values and the roll angle will have a value within the second range of values. The processing element 24 is also able to determine the period of time of travel for the sonar beam 26 to be transmitted, reflected from the bottom, and received by the sonar transducer 20. Thus, given the period of time of travel and the predictive modeling of when the attitude angle or the pitch angle and the roll angle will have values within the appropriate range of values, the processing element 24 may output the transmit electronic signal for the sonar transducer 20 to transmit the sonar beam 26 so that the reflection will be received when the sonar transducer 20 is in the reflection window 36 and the attitude angle has a value within the attitude range of angles or the pitch angle has a value within the first range of values and the roll angle has a value within the second range of values. In such situations, the sonar beam 26 may be transmitted and received when the vessel is not perfectly level but still while beam 26 remains within the desired performance range of transducer 20.

In other situations, the processing element 24 may determine, through the use of predictive modeling, that the value of the attitude angle may not be within the attitude range of values or the value of the pitch angle may not be within the first range of values and/or the value of the pitch angle may not be within the second range of values for a period of time greater than a particular threshold—say 2 or 3 seconds. In such situations, the processing element 24 may output the transmit electronic signal anyway in case the sonar beam 26 reflects off objects in the water, such as fish, which are not directly beneath the sonar transducer 20. In these situations, the display 14 may be able to display an underwater sonar image instead of the display 14, or a portion of the display 14, being blank while having to wait for attitude angle or the pitch angle and the roll angle to be within the appropriate range of values.

The processing element 24 may also determine and sets the gain of the receive amplifier 32 as necessary to compensate for the receive electronic signal having a lower amplitude when the value of the attitude angle increases beyond the attitude range of values or the value of the pitch angle increases beyond the first range of values and/or the value of the roll angle increases beyond the second range of values. As discussed above, the amplitude of the receive electronic signal output by the sonar transducer 20 decreases as the marine vessel 12 pitches and rolls. Using predictive modeling techniques, the processing element 24 may predict the values of the pitch angle and the roll angle and continuously vary the gain of the receive amplifier 32 in anticipation of the variation of the values of the attitude angle or the pitch angle and the roll angle.

In addition, the processing element 24 processes the receive electronic signal, after amplification, to derive or extract data which is used to generate underwater sonar images. The processing element 24 further controls the display 14 to display, or visually present, underwater sonar images which depict objects, such as fish, in the water and the bottom of the body of water.

The marine sonar system 10 may operate as follows. The sonar transducer 20 transmits the sonar beam 26 which reflects off the bottom of the body of water as well as objects in the water. The sonar transducer 20 also receives the reflections 28 and outputs the receive electronic signal, which includes characteristics that correspond to the reflections 28. The display 14 displays underwater sonar images that are derived from the receive electronic signal.

The attitude sensor 18 detects the motion of the marine vessel 12 and outputs attitude data, such as data indicating the attitude angle or the pitch angle and the roll angle of the marine vessel 12. The processing element 24 receives the attitude data and outputs the transmit electronic signal to instruct the sonar transducer 20 to transmit the sonar beam 26 based on attitude-related information, such as when the attitude angle (pitch and/or roll) has a value within the attitude range of angles or the pitch angle has a value within the first range of values and the roll angle has a value within the second range of values—that is, when the sonar transducer 20 is within the reflection window 36 or when the marine vessel 12 is level. The processing element 24 may also utilize predictive modeling to determine future values of the attitude angle or the pitch angle and the roll angle. Thus, the processing element 24 may output the transmit electronic signal when it determines that the sonar transducer 20 is within the reflection window 36 and that the attitude angle has a value within the attitude range of angles or the pitch angle has a value within the first range of values and the roll angle has a value within the second range of values when the reflections 28 of the sonar beam 26 are received. In addition, the processing element 24 may adjust the gain of the receive amplifier 32 to compensate for a varying amplitude of the receive electronic signal according to future values of the pitch angle and the roll angle.

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

What is claimed is:

1. A marine sonar system comprising:
a sonar transducer configured to:
transmit a sonar beam into a body of water according to a transmit electronic signal, receive reflections of the sonar beam, and
output a receive electronic signal according to the reflections of the sonar beam;
an attitude sensor configured to determine an attitude of a marine vessel with which the marine sonar system is utilized and to output an attitude electronic signal whose value varies according to the attitude; and
a processing element configured to:
receive the attitude electronic signal, and
based on the attitude electronic signal, control the output of the transmit electronic signal to the sonar transducer.

2. The marine sonar system of claim 1, wherein the processing element is further configured to:
determine a future value of an attitude utilizing the attitude electronic signal,
determine a period of time for when reflections of the sonar beam from a bottom of the body of water will be received by the sonar transducer, and
output the transmit electronic signal to the sonar transducer to transmit the sonar beam based on the future value of the attitude and the determined period of time.

3. The marine sonar system of claim 2, wherein the processing element is further configured to utilize a sinusoid summation technique to model the motion of the marine vessel to determine the future value of the attitude.

4. The marine sonar system of claim 1, further comprising:
a receive amplifier configured to amplify the receive electronic signal, the receive amplifier having a variable gain; and
wherein the processing element is further configured to:
determine a future value of an attitude utilizing the attitude electronic signal, and
determine and set the gain of the receive amplifier based on the future value of the attitude.

5. The marine sonar system of claim 1, further comprising:
a display configured to display underwater sonar images; and
wherein the processing element is further configured to:
process the receive electronic signal to derive data used to generate underwater sonar images, and
control the display to display the underwater sonar images.

6. The marine sonar system of claim 1, wherein the processing element is configured to output the transmit electronic signal to the sonar transducer only when the attitude electronic signal indicates that a pitch and a roll of the marine vessel is within a predetermined range.

7. A marine sonar system comprising:
a sonar transducer configured to:
transmit a sonar beam into a body of water according to a transmit electronic signal, receive reflections of the sonar beam, and
output a receive electronic signal according to the reflections of the sonar beam;
an attitude sensor configured to output an attitude electronic signal; and
a processing element configured to:
receive the attitude electronic signal and determine a pitch angle and a roll angle of a marine vessel with which the marine sonar system is utilized, and
output the transmit electronic signal to the sonar transducer to transmit the sonar beam when the pitch angle has a value within a first range of values and the roll angle has a value within a second range of values.

8. The marine sonar system of claim 7, wherein the processing element is further configured to:
determine future values of the pitch angle and the roll angle,
determine a period of time for when reflections of the sonar beam from a bottom of the body of water will be received by the sonar transducer, and
output the transmit electronic signal to the sonar transducer to transmit the sonar beam based on the future values of the pitch and roll angles and the determined period of time.

9. The marine sonar system of claim 8, wherein the processing element is further configured to utilize a sinusoid summation technique to model the motion of the marine vessel to determine future values of the pitch angle and the roll angle.

10. The marine sonar system of claim 7, further comprising:
a receive amplifier configured to amplify the receive electronic signal, the receive amplifier having a variable gain; and
wherein the processing element is further configured to:
determine future values of the pitch angle and the roll angle, and
determine and set the gain of the receive amplifier according to the future values of the pitch angle and the roll angle.

11. The marine sonar system of claim 7, further comprising:
a display configured to display underwater sonar images; and
wherein the processing element is further configured to:
process the receive electronic signal to derive data used to generate underwater sonar images, and
control the display to display the underwater sonar images.

12. The marine sonar system of claim 7, wherein the first range and the second range are determined by the processing element based on a beam width of the sonar beam.

13. The marine sonar system of claim 7, wherein the first range of values equals zero degrees plus or minus a first limit value.

14. The marine sonar system of claim 7, wherein the second range of values equals zero degrees plus or minus a second limit value.

15. A marine sonar system comprising:
a sonar transducer configured to:
transmit a sonar beam into a body of water according to a transmit electronic signal, receive reflections of the sonar beam, and
output a receive electronic signal according to the reflections of the sonar beam;
an attitude sensor configured to output an attitude electronic signal; and
a processing element configured to:
receive the attitude electronic signal and determine if a marine vessel with which the marine sonar system is utilized is level, and
output the transmit electronic signal to the sonar transducer to transmit the sonar beam when the marine vessel is level.

16. The marine sonar system of claim 15, wherein the processing element is further configured to—
determine a pitch angle and a roll angle based on the received attitude electronic signal, and
utilize the pitch angle and roll angle to determine if the marine vessel is level.

17. The marine sonar system of claim 16, wherein the processing element is further configured to:
determine future values of the pitch angle and the roll angle,
determine a period of time for when reflections of the sonar beam from a bottom of the body of water will be received by the sonar transducer, and
output the transmit electronic signal to the sonar transducer to transmit the sonar beam based on the future values of the pitch and roll angles and the determined period of time.

18. The marine sonar system of claim 16, wherein the processing element is further configured to utilize a sinusoid summation technique to model the motion of the marine vessel to determine future values of the pitch angle and the roll angle.

19. The marine sonar system of claim 16, further comprising:
a receive amplifier configured to amplify the receive electronic signal, the receive amplifier having a variable gain; and
wherein the processing element is further configured to:
determine future values of the pitch angle and the roll angle, and
determine and set the gain of the receive amplifier according to the future values of the pitch angle and the roll angle.

20. The marine sonar system of claim 15, wherein the attitude sensor and the processing element are integrated.
